(19) United States
(12) Patent Application Publication
(10) Pub. No.: US 2025/0212098 A1
(43) Pub. Date: Jun. 26, 2025

(54) SELECTING A NON-3GPP ACCESS NETWORK AND A COMMUNICATION NETWORK

(71) Applicant: Lenovo (Singapore) Pte. Limited, Singapore (SG)

(72) Inventors: Genadi Velev, Darmstadt (DE); Apostolis Salkintzis, Glika Nera (GR)

(73) Assignee: Lenovo (Singapore) Pte. Limited, Singapore (SG)

(21) Appl. No.: 18/849,168

(22) PCT Filed: May 13, 2022
(86) PCT No.: PCT/EP2022/063068

§ 371 Date: Sep. 20, 2024

(30) Foreign Application Priority Data
Mar. 22, 2022 (GR) 20220100252

(51) Int. Cl. H04W 48/16; H04W 48/18; H04W 60/04; H04W 84/12

(52) U.S. Cl. CPC H04W 48/16; H04W 48/18; H04W 60/04; H04W 84/12

(57) ABSTRACT

There is provided a method for a device. The method comprises receiving one or more generic container user data (GUD), wherein each GUD is received from a non-3GPP access network, wherein the non-3GPP access network supports at least one functionality provided by a communication network. Each GUD indicates: a set of communications networks supported by the non-3GPP access network, a connectivity to each of the set of communication networks that is supported by the non-3GPP access network, and at least one functionality provided by each communication network and that is supported by the non-3GPP access network. The method further comprises selecting a non-3GPP access network and a communication network based on the received one or more GUDs, and initiating a registration with the selected non-3GPP access network and the selected communication network.

### FIELD

The subject matter disclosed herein relates generally to the field of selecting a non-3gpp access network and a communication network. This document defines an apparatus, a method for a device, an apparatus in a non-3GPP access network, and a method in a non-3GPP access network.

### BACKGROUND

3GPP TS 24.302 v17.3.0, published December 2021 is titled “Access to the 3GPP Evolved Packet Core (EPC) via non-3GPP access networks; Stage 3”. This standard specification describes the discovery and network selection procedures for access to 3GPP Evolved Packet Core (EPC) via non-3GPP access networks and includes Authentication and Access Authorization using Authentication, Authorization and Accounting (AAA) procedures used for the interworking of the 3GPP EPC and the non-3GPP access networks.

IEEE Standard 802.11-2016 is titled “IEEE Standard for Information technology—Telecommunications and information exchange between systems—Local and metropolitan area networks—Specific requirements—Part 11: Wireless LAN Medium Access Control (MAC) and Physical Layer (PHY) Specifications”. This standard defines one medium access control (MAC) and several physical layer (PHY) specifications for wireless connectivity for fixed, portable, and moving stations (STAs) within a local area.

The 3GPP standards organization has defined in, for example 3GPP TS 24.302 v17.3.0, the structure and contents of a generic container user data (GUD) used as the payload in a 3GPP Cellular Network Access Network Query Protocol element (ANQP-element). The ANQP-element is specified in IEEE Standard 802.11.

### SUMMARY

A problem with existing networks is that a wireless communication device attempting to connect to a communication network via a non-3gpp access network may establish such a connection only to find that the functionality that it required the connection for is not available via the combination of a communication network and non-3gpp access network over which the connection has been established.

Disclosed herein are procedures for selecting a non-3gpp access network and a communication network. Said procedures may be implemented by an apparatus, a method for a device, an apparatus in a non-3GPP access network, and a method in a non-3GPP access network.

There is provided an apparatus comprising a receiver and a processor. The receiver is arranged to receive one or more generic container user data (GUD), wherein each GUD is received from a non-3GPP access network, wherein the non-3GPP access network supports at least one functionality provided by a communication network. Each GUD indicates: a set of communication networks supported by the non-3GPP access network, a connectivity to each of the set of communication networks that is supported by the non-3GPP access network, and at least one functionality provided by each communication network and that is supported by the non-3GPP access network. The processor is arranged to select a non-3GPP access network and a communication network based on the received one or more GUDs. The processor is further arranged to initiate a registration with the selected non-3GPP access network and the selected communication network.

There is further provided a method for a device. The method comprises receiving one or more generic container user data (GUD), wherein each GUD is received from a non-3GPP access network, wherein the non-3GPP access network supports at least one functionality provided by a communication network. Each GUD indicates: a set of communications networks supported by the non-3GPP access network, a connectivity to each of the set of communication networks that is supported by the non-3GPP access network, and at least one functionality provided by each communication network and that is supported by the non-3GPP access network. The method further comprises selecting a non-3GPP access network and a communication network based on the received one or more GUDs, and initiating a registration with the selected non-3GPP access network and the selected communication network.

There is further provided an apparatus in a non-3GPP access network, the apparatus comprising a transmitter and a receiver. The transmitter is arranged to send a generic container user data (GUD) to a wireless communications device, wherein the GUD indicates: a set of communication networks supported by the non-3GPP access network, a connectivity to each of the set of communication networks that is supported by the non-3GPP access network, and at least one functionality provided by each communication network and that is supported by the non-3GPP access network. The receiver is arranged to receive a registration request from the wireless communication device, the registration request initiating a registration with the selected non-3GPP access network and a selected communication network.

There is further provided a method in a non-3GPP access network, the method comprising: sending a generic container user data (GUD) to a wireless communication device. The GUD indicates: a set of communication networks supported by the non-3GPP access network, a connectivity to each of the set of communication networks that is supported by the non-3GPP access network, and at least one functionality provided by each communication network and that is supported by the non-3GPP access network. The method further comprises receiving a registration request from the wireless communication device, the registration request initiating a registration with the selected non-3GPP access network and a selected communication network.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for selecting a non-3gpp access network and a communication network will now be described, by way of example only, with reference to the accompanying drawings, in which:

FIG. 1 illustrates an example of a system comprising a deployment of an SNPN having a non-3GPP access network;

FIG. 2 depicts a user equipment apparatus;

FIG. 3 depicts further details of the network node;

FIG. 4 illustrates a method for a device;

FIG. 5 illustrates a method in a non-3GPP access network;

FIG. 6 illustrates the structure of a generic container;

FIG. 7 illustrates the coding of each IEI from FIG. 6;

FIG. 8 shows an example deployment scenario for trusted non-3GPP access network selection;

FIG. 9 shows an example format of an SNPN information IEI as described herein; and

FIG. 10 illustrates a system whereby a registration procedure is performed via a trusted non-3GPP access.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of Band C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

With the advance of 5th generation (5G) services and networks, it may be possible to deploy 5G networks as private networks, i.e. known as non-public networks (NPN) according to the 3GPP specifications. The NPNs can be deployed in one of the following ways: as part of the public network, which is known PLMN. In such cases the NPN is denoted as PNI-NPN; or as independent network which does not rely on the public network infrastructure (PNI) and it is called Standalone Non-Public Network (SNPN).

The SNPN may deploy 3GPP-specified access technology, e.g. LTE or NR, or it may deploy access technologies specified outside 3GPP; e.g. WLAN as specified in an IEEE 802.11 standard, which are referred to herein as non-3GPP access networks. This document focuses on SNPN deploying non-3GPP access network. The non-3GPP access network is directly connected to the 5G core network of the SNPN.

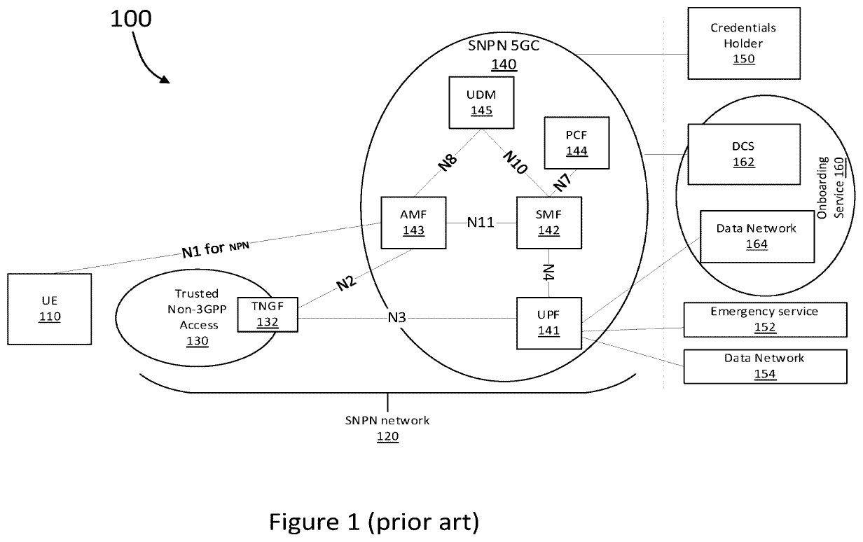

FIG. 1 illustrates an example of a system 100 comprising a deployment of an SNPN 120 having a non-3GPP access network 130. System 100 comprises a UE 110, a trusted non-3GPP access network 130, a SNPN 5G core 140, a credentials holder (CH) 150, an onboarding service 160, an emergency service 152 and a data network (DN) 154 which may be the internet. The trusted non-3GPP access network 130 comprises a Trusted Non-3GPP Access Network Gateway Function (TNGF) 132. SNPN 5GC 140 comprises a user plane function (UPF) 141, a session management function (SMF) 142, an Access and Mobility management Function (AMF) 143, a policy and control function (PCF) 144, and a User data management (UDM) 145. The onboarding service 160 comprises a Default Credentials Server (DCS) 162 that provides authentication for onboarding, and a data network (DN) 154 which may be for the onboarding service. The credentials holder (CH) 150 may provide authentication to access the SNPN 140. The UE 110 may hold credentials matching those from the credentials holder 150. The interfaces used between different components of system 100 are also illustrated. The UE 100 may comprise a user equipment apparatus 200 or a UE 1010 as described herein. The TNAN 130 may comprise a trusted non-3GPP access network, a network node 300, a wireless access network 820, 830, or a TNAN 1030 as described herein.

Currently, a non-3GPP access network may advertise a list of PLMNs to which the non-3GPP access network supports 5G connectivity. This enables a 5G UE to determine which non-3GPP access network can be selected, when the 5G UE wants to register with a specific PLMN over a non-3GPP access network.

When a non-3GPP access network advertises that it supports 5G connectivity with a PLMN, it is assumed that the non-3GPP access network supports connectivity to any service offered in this PLMN. A UE can access any of its subscribed services in an PLMN. However, in case of SNPN selection, there might be the case that the UE selects an SNPN depending on the services offered by this SNPN.

3GPP has specified that 3GPP accesses (e.g. NR) connected to SNPNs may broadcast the following indications: an indication per SNPN of whether access using credentials from a Credentials Holder (CH) is supported; and onboarding enabled indication which identifies that the SNPN supports connectivity for Onboarding service.

Where an indication per SNPN of whether access using credentials from a Credentials Holder (CH) is supported, the cell may further broadcast one of the following: Group ID for Network Selection (GINs) per SNPN; and an indication that the SNPN allows registration attempts from UEs that are not explicitly configured to select the SNPN, i.e. the broadcasted NID or GIN is not present in the Credentials Holder controlled prioritized lists of preferred SNPNs/GINs in the UE.

Where an onboarding enabled indication identifies that the SNPN supports connectivity for Onboarding service, the onboarding enabled indication indicates whether onboarding is currently enabled for the SNPN. The onboarding enabled indication is broadcasted per cell, e.g. to allow start of the onboarding procedure only in parts of the SNPN.

FIG. 1 shows a trusted non-3GPP access network 130 connected via the N2and N3 interfaces with the SNPN 5G core network (5GC) 140. A registered UE 110 establishes N1 connection with the AMF 143 via the NAS protocol. Usually, UEs which are considered as subscribers of the SNPN 120 (e.g. the SNPN is part of the list of preferred SNPN for selection) will attempts a registration. However, newly, i.e. in 3GPP Rel-17 specifications, the SNPN 120 supports also registration of UEs which are not subscribers of the SNPN 120 (i.e. functionalities A and B in the list below). The SNPN network 120 may provide one of the following functionalities to UEs:
A. Network access using credentials from a Credentials Holder (CH) where the CH is used to authenticate and authorized the UE during the primary network authentication. The UEs interested in such a service are subscribers of the CH.
B. Onboarding service where the UE having default credentials is authenticated and authorized by a Default Credentials Server (DCS) during the primary network authentication. After the UE establishes a PDU Session for Onboarding service, the SNPN would provide connectivity to a data network offering the provisioning server functionality for onboarding.
C. Emergency service or other services to which connectivity is offered. Please note that only some SNPNs may support Emergency service, whereas other SNPNs do not support Emergency service.
D. Connectivity to other services, e.g. Internet.

The services A and B are special functionality offered to UEs to register with the SNPN without being subscribers of the SNPN. It is beneficial if the UE is aware about the support of such services before the UE attempts to select and register with the SNPN.

While FIG. 1 shown an SNPN network 120, the methods and apparatus describe herein may also apply to a PLMN network, such as when a PNI-NPN supports an onboarding service.

There is a problem with known arrangements in that the UE is unable to select a trusted non-3GPP access network which offers connectivity to a network (e.g. SNPN or PLMN) and that supports functionalities like registration without being a subscriber of the network.

Furthermore, in a different scenario, it is possible that the trusted non-3GPP access network is configured to support one or more tracking area IDs (TAIs), i.e. the TNGFs are deployed to support a one or more TAIs. In one example, there may be two available non-3GPP access networks, e.g. WLAN, configured with SSID #1 and SSID #2, and both non-3GPP access networks can be connected to the same 5GC (i.e. same PLMN or SNPN). The WLAN with SSID #1 may be configured with a TAI #1 and the WLAN with SSID #2 may be configured with a TAI #2. The UE may be allowed to access only a single TAI, i.e. TAI #1 or TAI #2. In such a case, it would be beneficial that the UE is aware about which TAI is supported by each of the available (trusted) non-3GPP access networks. It should be noted that the coverage of the WLAN with SSID #1 and the WLAN with SSID #2 may be overlapping or may be adjacent.

Furthermore, it is not clear how the UE can know the TAI(s) supported by the (trusted) non-3GPP access networks which provide connectivity to 5GC or EPC.

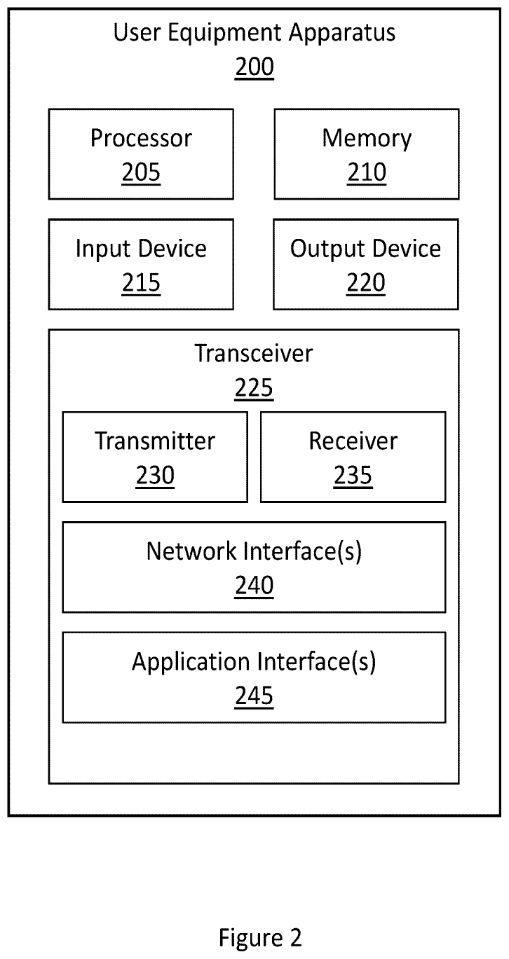

FIG. 2 depicts a user equipment apparatus 200 that may be used for implementing the methods described herein. The user equipment apparatus 200 is used to implement one or more of the solutions described above. The user equipment apparatus 200 may comprise a UE 110 or a UE 1010 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit.

Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

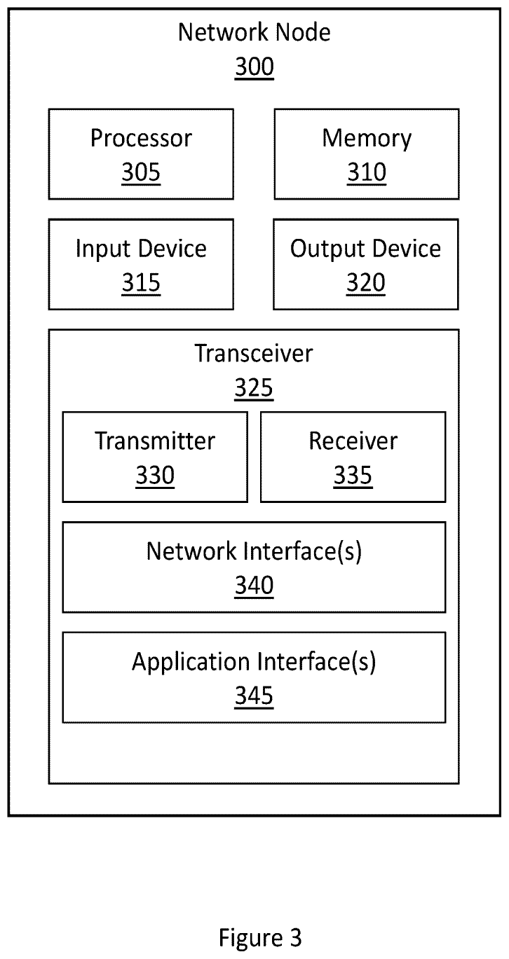

FIG. 3 depicts further details of the network node 300 that may be used for implementing the methods described herein. The network node 300 may be one implementation of an entity in the wireless communications network. The network node 300 may comprise a trusted non-3GPP access network, a TNAN 130, a wireless access network 820, 830, or a TNAN 1030 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

There is provided an apparatus comprising a receiver and a processor. The receiver is arranged to receive one or more generic container user data (GUD), wherein each GUD is received from a non-3GPP access network, wherein the non-3GPP access network supports at least one functionality provided by a communication network. Each GUD indicates: a set of communication networks supported by the non-3GPP access network, a connectivity to each of the set of communication networks that is supported by the non-3GPP access network, and at least one functionality provided by each communication network and that is supported by the non-3GPP access network. The processor is arranged to select a non-3GPP access network and a communication network based on the received one or more GUDs. The processor is further arranged to initiate a registration with the selected non-3GPP access network and the selected communication network.

The set of communication networks supported by the non-3GPP access network and the connectivity to each of the set of communication networks that is supported by the non-3GPP access network may comprise any of “PLMN List with S2a Connectivity IE”, “PLMN List with trusted 5G Connectivity IE”, and “PLMN List with trusted 5G Connectivity-without-NAS IE”. For example, the PLMN List with S2a connectivity information element is used by the WLAN to indicate the PLMNs to which the WLAN provides S2a connectivity.

The apparatus may be a user equipment (UE). The GUD as defined above, allows the apparatus to select both a non-3GPP access network and a communication network that fulfill any network functionalities that the apparatus requires. For example, such network functionality might include i) support for registration with credentials from a credential holder or ii) support for UE onboarding. Such network selection according to functionality selection is provided in addition to any selection according to connectivity the apparatus may perform. In practice, the apparatus selects a non-3GPP access network and a communication network according to both connectivity and functionality requirements of the apparatus.

The selection of a non-3GPP access network and a communication network may also be based on at least one of: service requirements determined at the apparatus; and a configuration determined at the apparatus.

The apparatus may further comprise a storage component arranged to store configuration and/or capability information.

The configuration information may indicate a configuration of the apparatus. The capability information may indicate a capability of the apparatus. For example, the apparatus may create a list of available non-3GPP access networks and communication networks. The apparatus may select the non-3GPP access network to access from this list based primarily on configuration and/or capability information stored at the apparatus. Configuration information and/or capability information stored at the apparatus may indicate that the apparatus is set (or configured) to operate in a specific mode, e.g. to perform a network access using identifier and credentials from a Credentials Holder, or to perform a network access in order to onboard the device. By way of further example, it should be noted that for automatic network selection the apparatus receives an input based on which criteria to perform the selection. The apparatus may receive the input from a configuration layer or a higher layer. For example, a mode of operation of the apparatus may identify that “the apparatus is looking for network to perform onboarding”; or “the apparatus is looking for a network to access with ID and credentials from a credentials holder”.

For example, the functionality might comprise an emergency communication service, a localized service, onboarding of a device, or registration with credentials from a credentials holder.

The GUD may additionally include information about tracking area identities (TAIs) supported by the non-3GPP access network from which the GUD is received.

The supported functionalities associated with each of the communication networks may comprise at least one of: network access using credentials from a Credentials Holder; a list of one or more Group IDs for Network Selection; registration without explicit SNPN selection configuration; a device onboarding service; a list of services offered by the SNPN; and identities or human readable names of functionalities or services. The list of services offered by the SNPN may include at least one of Emergency, Internet connectivity, localized services.

The selected communication network may be a standalone non-public network and the selected non-3GPP access network may be a WLAN.

The apparatus may further comprise a transmitter arranged to transmit to the non-3GPP access network an establishment cause indicating at least one of: a request for network access for device onboarding, or network access for using a localized service.

The network access for using a localized service may be an establishment cause that the UE wants to access the network acting as hosting network. The establishment cause may indicate network access for hosting network.

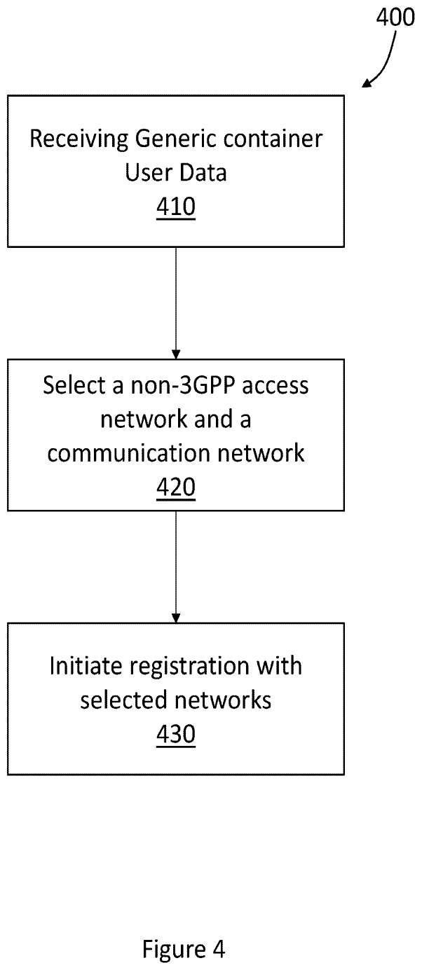

FIG. 4 illustrates a method 400 for a device. The method 400 comprises receiving 410 one or more generic container user data (GUD), wherein each GUD is received from a non-3GPP access network, wherein the non-3GPP access network supports at least one functionality provided by a communication network. Each GUD indicates: a set of communications networks supported by the non-3GPP access network, a connectivity to each of the set of communication networks that is supported by the non-3GPP access network, and at least one functionality provided by each communication network and that is supported by the non-3GPP access network. The method 400 further comprises selecting 420 a non-3GPP access network and a communication network based on the received one or more GUDs, and initiating 430 a registration with the selected non-3GPP access network and the selected communication network.

The selecting of a non-3GPP access network and a communication network may also be based on at least one of: service requirements determined at the apparatus; and a configuration determined at the apparatus.

The method may further comprise storing configuration and/or capability information.

The selection may also be based on both connectivity and functionality requirements determined at the device.

There is further provided an apparatus in a non-3GPP access network, the apparatus comprising a transmitter and a receiver. The transmitter is arranged to send a generic container user data (GUD) to a wireless communications device, wherein the GUD indicates: a set of communication networks supported by the non-3GPP access network, a connectivity to each of the set of communication networks that is supported by the non-3GPP access network, and at least one functionality provided by each communication network and that is supported by the non-3GPP access network. The receiver is arranged to receive a registration request from the wireless communication device, the registration request initiating a registration with the selected non-3GPP access network and a selected communication network.

The apparatus sending a GUD as defined above, allows the wireless communications device to select both a non-3GPP access network and a communication network that fulfill any functionalities that the wireless communications device requires. For example, such functionality might include support for registration without being a subscriber of the network. The selected communication network may be selected by the wireless communications device. The selection may also be based on service requirements determined at the device.

The GUD additionally includes information about tracking area identities (TAIs) supported by the non-3GPP access network from which the GUD is received.

The supported functionalities associated with each of the communication networks may comprise at least one of: network access using credentials from a Credentials Holder; a list of one or more Group IDs for Network Selection; registration without explicit SNPN selection configuration; an onboarding service; a list of services offered by the SNPN; and/or identities or human readable names of functionalities or services.

The list of services offered by the SNPN may include at least one of Emergency, Internet connectivity, localized services.

The apparatus may further comprise a receiver arranged to receive an establishment cause, wherein the establishment cause may be one of: network access for device onboarding; or network access for using a localized service. The establishment cause may be received from a user equipment. The apparatus may further comprise a transmitter arranged to send to the communication network the establishment cause received by the receiver.

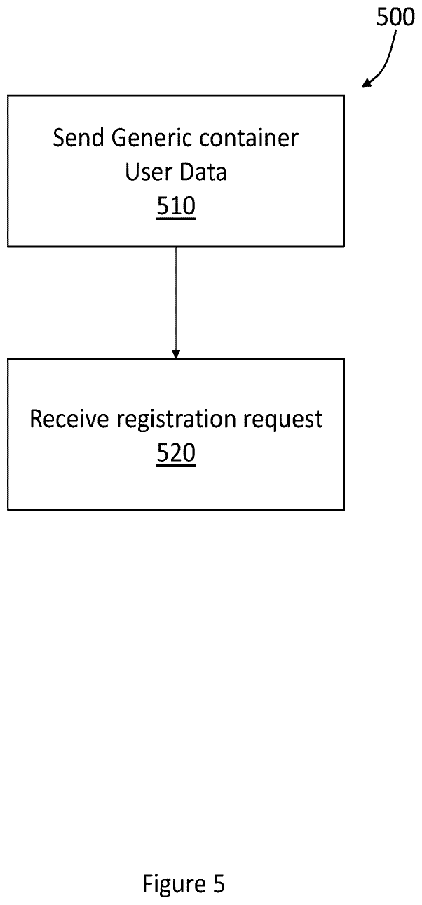

FIG. 5 illustrates a method 500 in a non-3GPP access network, the method 500 comprising: sending 510 a generic container user data (GUD) to a wireless communication device. The GUD indicates: a set of communication networks supported by the non-3GPP access network, a connectivity to each of the set of communication networks that is supported by the non-3GPP access network, and at least one functionality provided by each communication network and that is supported by the non-3GPP access network. The method 500 further comprises receiving 520 a registration request from the wireless communication device, the registration request initiating a registration with the selected non-3GPP access network and a selected communication network.

The selected communication network is selected by the wireless communications device.

The selection may also be based on service requirements determined at the device.

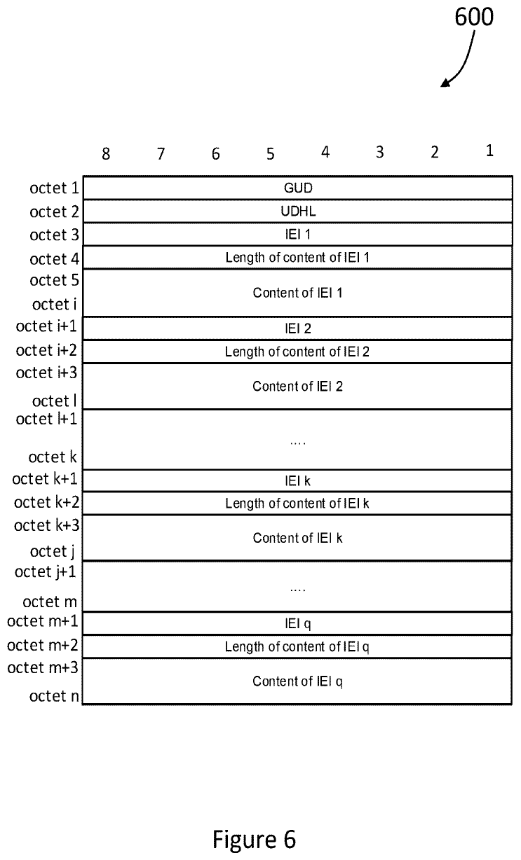

A generic container user data (GUD) used as the payload in the 3GPP Cellular Network ANQP-element is specified in IEEE Standard 802.11. FIG. 6 illustrates the structure of the generic container. In FIG. 6, the Generic container User Data (GUD) indicates the protocol version of the generic container which is currently “00000001” and the user data header length (UDHL) indicates the length of the generic container after

UDHL octet. Both GUD and UDHL are encoded in binary format.

Information element identity (IEI) are according to 3GPP TS 24.302 v17.3.0, currently defined as:

| | |
|---|---|
| 00000000 | PLMN List |
| 00000001 | PLMN List with S2a connectivity |
| 00000010 | PLMN List with trusted 5G connectivity |
| 00000011 | PLMN List with trusted 5G connectivity-without-NAS |
| 00000100 | |
| To | |
| 11111111 | Reserved. |

The Information Element Identities (IEIs) listed above are used by the network to indicate a list of PLMNs which may provide certain properties such as S2a connectivity or trusted 5G connectivity and can be selected from the wireless location area network (WLAN).

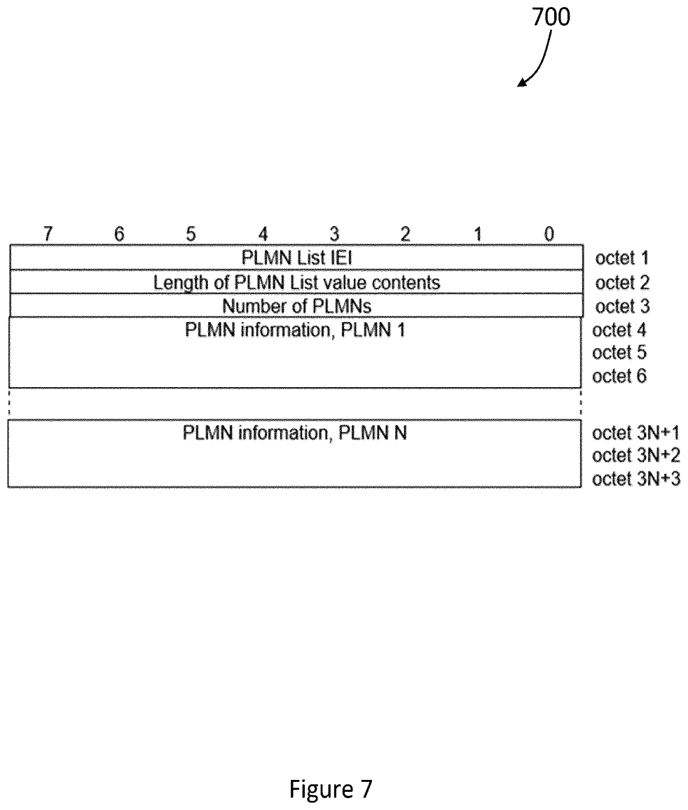

FIG. 7 illustrates the coding of each IEI from FIG. 6. The PLMN List IEI has the value of “00000000”. The “Number of PLMNs” (octet 3) contains the number of PLMN information items in the list. PLMN information contains the PLMN ID, e.g. MCC and MNC coded in 3 bytes.

The current arrangements based on the 3GPP Cellular Network Access Network Query Protocol element (ANQP-element) provide the list of PLMNs supporting a specific type of connectivity to the non-3GPP access network, but those current arrangements fail to provide any possibility to provide additional information, e.g. to announce any specific service which may be supported by the network.

The arrangements described herein allow the non-3GPP access network to advertise (or announces) specific supported functionalities or offered services by the network (e.g. 5GC or EPC). For example, the supported functionalities may be A) network access using credentials from a Credentials Holder (CH) or B) Onboarding service. The solutions presented herein allow a UE, which wants to establish connectivity via trusted non-3GPP access network (N3GPP AN), to select an SNPN and a trusted non-3GPP access network (TNAN) to connect to use specific functionalities or services.

The arrangements described herein may facilitate announcing network supported services to allow N3GPP AN discovery and/or selection. In other words, the N3GPP AN is able to announce the services supported by each of the networks (e.g. SNPN or PLMN) to which 5G connectivity is supported.

To facilitate this, the N3GPP AN is configured to be aware about the services (and associated service information) supported by the networks (SNPN or PLMN) to which 5G connectivity is supported.

Further, the ANQP information sent to the UE may include for each SNPN, to which 5G connectivity is supported, a list of supported functionalities or services (and associated service information) and list of supported tracking area IDs (list of TAIs). Such functionality information is sent in addition to any connectivity information that may be sent. For example, the list of supported functionalities may include:
a. an indication that the network access using credentials from a CH is supported. This may in addition include the information: a list of GINs and/or an indication that the SNPN allows registration from UEs that are not explicitly configured to select the SNPN;
b. an indication that onboarding service is supported;
c. one or more indications that specific service, e.g. Emergency, Internet connectivity, is supported.

Furthermore, the UE receives the enhanced ANQP information from the available networks. The UE constructs a list of candidate N3GPP ANs and candidate SNPNs. While constructing the candidate N3GPP ANs and candidate SNPNs, the UE considers the received supported functionalities, connectivites and services and also the functionalities, connectivites or services which the UE wants to use.

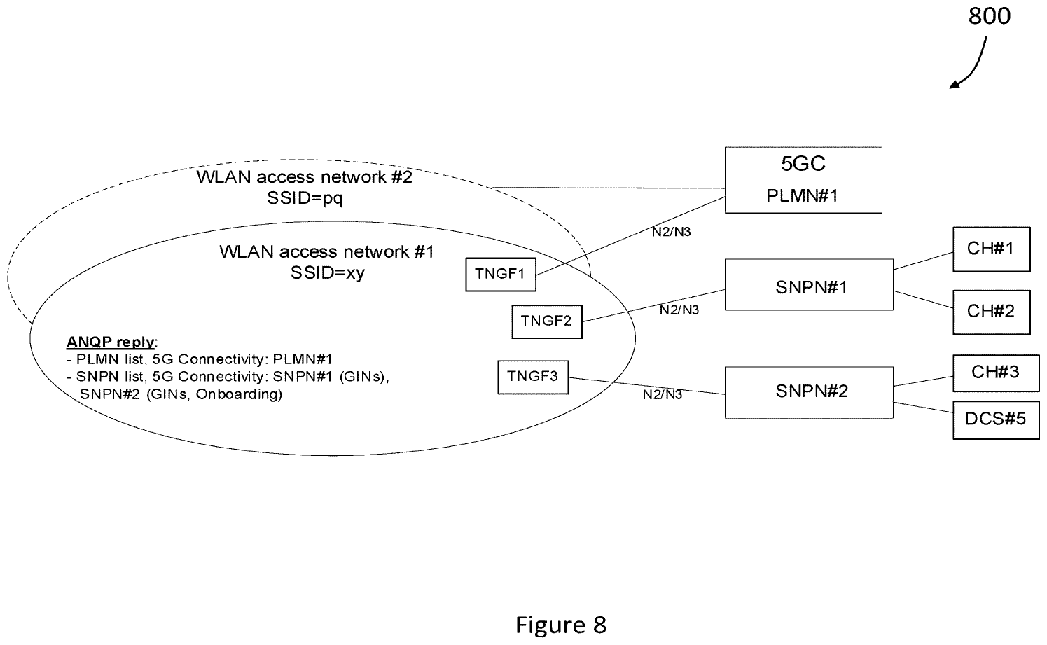

FIG. 8 shows an example deployment scenario 800 for trusted non-3GPP access network selection. The figure shows two WLAN access networks (N3GPP ANs): WLAN access network #1 820 configured with SSID=xy, and WLAN access network #2 830 configured with SSID=pq. The WLAN access network #1 820 configured with SSID=xy may provide 5G connectivity to 3 networks: PLMN #1 840, SNPN #1 850, and SNPN #2 860. In addition to other possible services, the SNPN #1 850 provides network access using credentials from a CH #1 851 and CH #2 852. In addition to other possible services, the SNPN #2 860 provides network access using credentials from a CH #3 863 and onboarding service. The onboarding service is provided for UEs having default credentials from the default credentials server DCS #5 865. The wireless access networks 820, 830 may comprise a trusted non-3GPP access network, a TNAN 130, a network node 300, or a TNAN 1030 as described herein.

It is proposed that the ANQP information provided to the UE is enhanced to include service information associated with the one or more SNPNs to which 5G Connectivity is supported. In addition, for each SNPN ID, the N3GPP AN provides service information about the supported services (e.g. network access using credentials from a CH is supported, or onboarding service is supported).

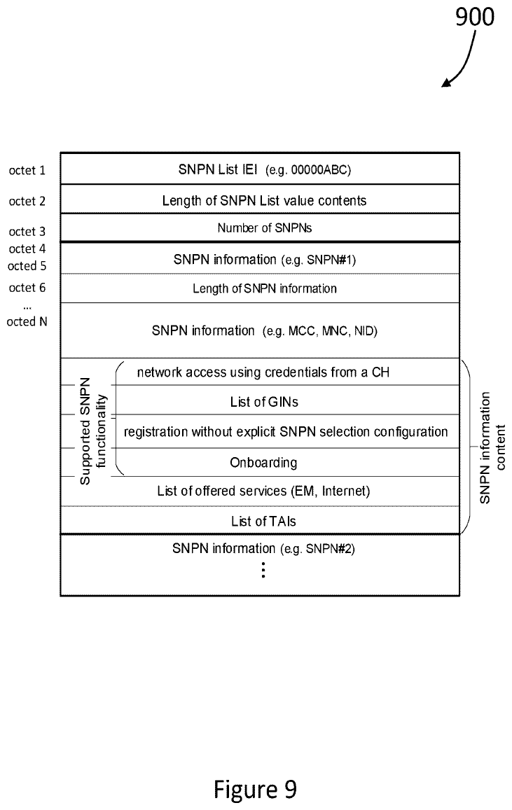

In the example of FIG. 8, the ANQP is enhanced to include the following information: SNPN #1 850 supports list of GINs; SNPN #2 860 supports list of GINs and Onboarding service. Further information may be advertised by the WLAN, i.e. included in the ANQP as described below in relation to FIG. 9.

If the UE is interested in 5G connectivity and the UE receives a list of PLMNs and a list of SNPNs supporting 5G connectivity as shown in FIG. 8, the UE may determine to select an SNPN network or a PLMN network based on various criteria, for example, any one of the following.
1) On implementation means.
2) Based on the configuration. For example, some applications/services of the UE require PLMN registration whereas other services may require SNPN registration. Such UE applications may trigger a registration to PLMN or SNPN.
3) The UE utilizes information stored in the SIM or in the mobile equipment (ME) such as “User Controlled PLMN Selector with Access Technology”, “Operator controlled PLMN Selector with Access Technology”, “Operator controlled SNPN Selector with Access Technology”, “user controlled prioritized list of preferred SNPNs” or “credentials holder controlled prioritized list of preferred SNPNs”, “credentials holder controlled prioritized list of Group IDs for Network Selection (GINs)”, etc. For example, if the UE is configured merely with “user controlled prioritized list of preferred SNPNs” or “credentials holder controlled prioritized list of preferred SNPNs”, then the UE attempts to select corresponding SNPNs. If the UE is configured merely with “User Controlled PLMN Selector with Access Technology” and/or “Operator controlled PLMN Selector with Access Technology”, the UE attempts to select corresponding PLMNs.
4) The UE may consider the type of SUPI it wants to use for the registration with the network. For example, if the SUPI is of NAI type (e.g. network specific identifier, NSI), the UE may consider to select SNPNs. If the SUPI is of IMSI type, the UE may consider selecting PLMNs.
5) The advertised capabilities of the discovered non-3GPP access networks or discovered SNPNs.

FIG. 9 shows an example format of an SNPN information IEI as described herein. The GUD format and the Information Element Identity (IEI) according to 3GPP TS 24.302 v17.3.0 are shown in FIG. 6. As described herein new IEI types are defined as follows:

| | |
|---|---|
| 00000000 | PLMN List |
| 00000001 | PLMN List with S2a connectivity |
| 00000010 | PLMN List with trusted 5G connectivity |
| 00000011 | PLMN List with trusted 5G connectivity-without-NAS |
| 00000ABC | SNPN List with trusted 5G (where the “ABC” can be e.g. |
| | “100” or other appropriate binary code) |
| 00000DEF | SNPN List with trusted 5G connectivity-without-NAS |
| | (where the “DEF” can be e.g. “101” or other appropriate |
| | binary code) |

In any of the new proposed “SNPN List with trusted 5G” or “SNPN List with trusted 5G connectivity-without-NAS” a new SNPN information IEI container may be provided such as that illustrated in FIG. 9.

The information container of FIG. 9 shows the list of SNPNs may contain a specific information for each SNPN. For example, the detailed description is shown with respect to the SNPN #1. The “SNPN information (e.g. SNPN #1)” includes a newly introduced “SNPN information content”. In general the SNPN information may include one or more of:
Length of SNPN information container.
SNPN information which identifies the SNPN ID, e.g. MCC, MNC, NID.
SNPN information content.

The SNPN information content may comprise:
List of supported SNPN functionalities (or type of registration services), e.g.
   network access using credentials from a CH;
   list of one or more GINs;
   registration without explicit SNPN selection configuration, which means that the SNPN allows registration from UEs that are not explicitly configured to select the SNPN;
   Onboarding service;
List of services offered by the SNPN. These are services to which connectivity is offered by the SNPN. For example the list of services may comprise:
   Emergency (EM) service;
   Internet connectivity service
   Localized services (e.g. identified by Service ID).
List of TAIs which are associated with the N3GPP AN.

The above listed parameters, which may be one octet long, can be coded in octets length which means that the parameters may be at least one octet in length, but they can be multiple octets in length.

In addition, the “list of supported SNPN functionality” or “list of services offered by the SNPN” may include the identities of the service providers to which the services are supported. For example, this information may include one or more of:
the identity of the CH, e.g. domain name in form of NAI or a human readable name;
the identity of the onboarding service provider, e.g. domain name from the identifier of the default credentials in form of NAI or a human readable name;
the identity of the provided localized service, e.g. Service ID in form of string of characters or a human readable name.

The non-3GPP access network support of advertising (or announcing) a human readable name, it is possible that a manual selection of trusted non-3GPP access network and correspondingly connected SNPN is possible, as the human readable name can be displayed to the user and the user may insert a manual selection.

A benefit of such a solution is that the UE is able to discover the supported functionalities or the offered services by SNPNs connected to the N3GPP AN. By using service information the UE is able to select an appropriate SNPN and corresponding N3GPP AN.

FIG. 8 and FIG. 9 describe enhancements to the ANQP for the SNPN information. This is shown as an example and the same or similar ANQP enhancements (or GUD format enhancements) can be also applicable to PLMNs.

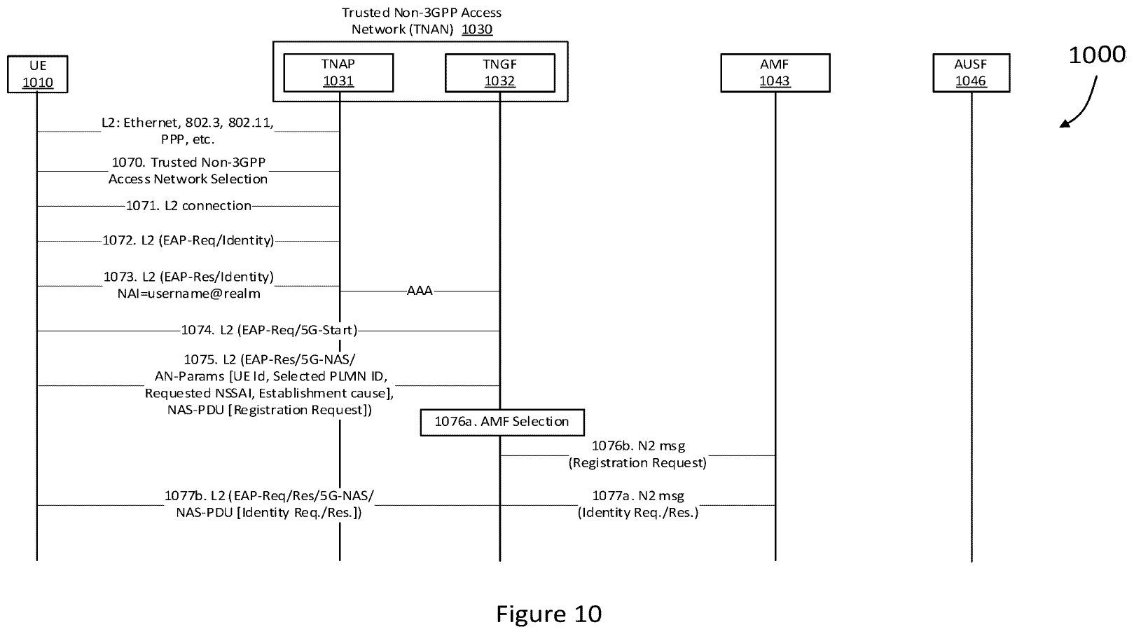

FIG. 10 illustrates a system 1000 whereby a registration procedure is performed via a trusted non-3GPP access. The system 1000 comprises a UE 1010, a TNAN 1030, an AMF 1043 and an AUSF 1046. The TNAN 1030 comprises a TNAP 1031 and a TNGF 1032. The UE 1010 connects to a trusted non-3GPP Access Network (TNAN) 1030 and it also registers to 5GC, via the TNAN 1030, by using an EAP-based procedure. The link between the UE 1010 and the TNAN 1030 can be any data link (L2) that supports EAP encapsulation, e.g. PPP, PANA, Ethernet, IEEE 802.3, IEEE 802.11, etc. The interface between the TNAP 1031 and TNGF 1032 is an AAA interface. The UE 1010 may comprise a user equipment apparatus 200 or a UE 110 as described herein. The TNAN 1030 may comprise a trusted non-3GPP access network, a TNAN 130, a network node 300, or a wireless access network 820, 830 as described herein.

At 1070, the UE 1010 selects a PLMN and a TNAN for connecting to this PLMN by using the Trusted Non-3GPP Access Network selection procedure specified in clause 6.3.12 of TS 23.501 v17.3.0. During this procedure, the UE discovers the PLMNs with which the TNAN supports trusted connectivity (e.g. “5G connectivity”).

At 1071, a layer-2 connection is established between the UE 1010 and the TNAP 1031. In the case of an IEEE Standard 802.11, this step corresponds to an 802.11 Association. In the case of PPP, this step corresponds to a PPP LCP negotiation. In other types of non-3GPP access (e.g. Ethernet), this step may not be required.

At 1072 and 1073, an EAP procedure is initiated. EAP messages are encapsulated into layer-2 packets, e.g. into IEEE 802.3/802.1x packets, into IEEE 802.11/802.1x packets, into PPP packets, etc. The NAI provided by the UE indicates that the UE requests “5G connectivity” to a specific PLMN, e.g. NAI=“<any_username>@nai.5gc. mnc<MNC>.mcc<MCC>.3gppnetwork.org”. This NAI triggers the TNAP to send an AAA request to a TNGF, which operates as an AAA proxy. Between the TNAP and TNGF the EAP packets are encapsulated into AAA messages. The AAA request also include the TNAP identifier, which can be treated as the User Location Information.

At 1074 onwards, an EAP-5G procedure is executed. A TNGF key (instead of an N3IWF key) is created in the UE 1010 and in the AMF 1043 after a successful authentication. The TNGF key is transferred from the AMF 1043 to TNGF 1032 within the N2 Initial Context Setup Request. The TNGF 1032 derives a TNAP key, which is provided to the TNAP 1031. The TNAP key depends on the non-3GPP access technology (e.g. it is a Pairwise Master Key in the case of IEEE Std 802.11).

At 1075, the UE 1010 shall include the Requested NSSAI in the AN parameters only if allowed for the trusted non-3GPP access. The UE shall also include a UE Id in the AN parameters, e.g. a 5G-GUTI if available from a prior registration to the same PLMN.

In the N2 message sent in step 1076b, the TNGF includes a UE Location Information (ULI) that contains a “null” IP address (e.g. 0.0.0.0) because the UE is not yet assigned an IP address. After the UE is assigned an IP address, the TNGF includes this address in subsequent N2 messages.

FIG. 10 is cropped from the FIG. 4.12a.2.2-1 in 3GPP TS 23.502 v17.3.0, wherein the steps 1071-1077 are shown which are of interest herein. Step 1075 shows that the UE sends a layer 2 (L2) message to the TNGF 1032, which contains the 5G-NAS packet which in turn comprises: access network (AN) parameters which may include UE ID (e.g. a 5G-GUTI if available from a prior registration to the same PLMN), selected PLMN ID, establishment cause and optionally Requested NSSAI. The AN parameters contain information that is used by the N3IWF for selecting an AMF in the 5G core network. The 5G-NAS packet additionally comprises a NAS-PDU which may include the registration request message.

The AN parameter establishment cause provides the reason for requesting a signaling connection with 5GC. According to the arrangements described herein, the AN parameter establishment cause is modified and may indicate that the reason for the UE access the network is to use a specific network functionality (e.g. UE onboarding) or service provided by the network (e.g. localized services). In particular, the establishment cause may indicate that the UE 1010 wants to register with the selected network (e.g. selected SNPN) for onboarding service. The TNGF 1032 is also required to support the new establishment causes. For example, if the TNGF 1032 receives an establishment cause for UE 1010 onboarding, the TNGF 1032 may attempt to select an AMF 1043 which supports the UE 1010 onboarding service. In general, the TNGF 1032 selects an AMF 1032 based on the received AN parameters and local policy.

Furthermore, the TNGF 1032 (as part of trusted non-3GPP access network) provides the new establishment cause to the AMF 1043 in the N2 signaling, e.g. the establishment cause to indicate network access for UE 1010 onboarding. By this, the impacts to the TNGF 1032 may be considered as impacts to the non-3GPP access network.

In case of the UE onboarding service, the UE 1010 also indicates a request for onboarding in the NAS registration request message. For example, the UE 1010 uses 5GS Registration Type to the value “SNPN Onboarding” indicating that the registration request is for onboarding.

Additionally, the UE 1010 may indicate a selected SNPN (e.g. PLMND and NID) in the AN parameters sent to the TNGF 1032. The N2 interface signaling between the TNGF 1032 and AMF 1043 may be enhanced to include the SNPN ID.

The structure and contents of the generic container user data (GUD) described herein may be used as the payload in a 3GPP Cellular Network Access Network Query Protocol element (ANQP-element). The ANQP-element may be used as specified in IEEE Standard 802.11.

As described herein, a UE is able to receive and process all of the newly introduced parameters of the SNPN information content. Further, the UE is able to construct a list of non-3GPP access networks and correspondingly connected SNPNs which support the connectivity's and functionalities which the UE requires.

Further, as described herein, the non-3GPP access network, which may be a WLAN, is able to use enhanced ANQP information to announce the support of: one or more services supported by the networks (e.g. 5G network, PLMN or SNPN) connected to the WLAN network; and the list of TAIs supported by the networks (e.g. 5G network, PLMN or SNPN) connected to the WLAN network.

The TNGF (as part of non-3GPP access network) as described herein is able to receive a new establishment cause (e.g. network access for UE onboarding) in the AN parameters. The TNGF may further be able to send a new establishment cause (e.g. network access for UE onboarding) in the N2 signaling to the AMF.

Accordingly, there is provided a method for a device to select a communication network connected and a non-3GPP access network, the method comprising the following steps: receiving one or more generic container user data (GUD) from one or more non-3GPP access networks, whereas the GUD comprises information about supported services associated with each of the communication networks; selecting the non-3GPP access networks and the communication network based on the supported services by the communication networks and the desired services by the device; and initiating a registration with the selected non-3GPP access network and the selected communication network.

The GUD may include information about the tracking area identities (TAIs) supported by the non-3GPP access network.

The supported functionalities associated with each of the communication networks may comprise at least one of:
a. network access using credentials from a CH;
b. list of one or more GINs;
c. registration without explicit SNPN selection configuration;
d. Onboarding service;
e. List of services offered by the SNPN (e.g. Emergency, Internet connectivity, localized services, etc.);
f. Identities or human readable names of functionalities or services.

The communication network may be a standalone non-public network and the non-3GPP access network is a WLAN.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive information from a non-3GPP access network, wherein the non-3GPP access network supports at least one functionality provided by a communication network, and wherein the information comprises:
a set of communication networks supported by the non-3GPP access network;
a connectivity to each communication network of the set of communication networks that is supported by the non-3GPP access network; and
at least one functionality provided by each communication network and that is supported by the non-3GPP access network;
select a non-3GPP access network and a communication network based at least in part on the received information; and
initiate a registration with the selected non-3GPP access network and the selected communication network.

2. The of claim 1, wherein the selection of a non-3GPP access network and a communication network is based on at least one of: service requirements determined at the UE or a configuration determined at the UE.

3. The UE of claim 1, further comprising a storage component arranged to store one or more of configuration or capability information.

4. The UE of claim 1, wherein the information further comprises information about tracking area identities (TAIs) supported by the non-3GPP access network from which the information is received.

5. The UE of claim la wherein functionalities supported by each communication network comprise at least one of:
network access using credentials from a Credentials Holder;
a list of one or more Group IDs for Network Selection;
registration without explicit Standalone Non-Public Network (SNPN) selection configuration;
a device onboarding service;
a list of services offered by a SNPN; or
identities or human readable names of functionalities or services.

6. The UE of claim 1, wherein the selected communication network comprises a standalone non-public network and the selected non-3GPP access network comprises a Wireless Local Area Network.

7. The UE of claim 1, wherein the at least one processor is configured to cause the UE to transmit to the non-3GPP access network an establishment cause indicating at least one of:
a request for network access for device onboarding; or,
network access for using a localized service.

8. A method performed by a user equipment (UE), the method comprising:
receiving information from a non-3GPP access network, wherein the non-3GPP access network supports at least one functionality provided by a communication network, and wherein the information comprises:
a set of communications networks supported by the non-3GPP access network;
a connectivity to each of the set of communication networks that is supported by the non-3GPP access network; and
at least one functionality provided by each communication network and that is supported by the non-3GPP access network;
selecting a non-3GPP access network and a communication network based at least in part on the received information; and
initiating a registration with the selected non-3GPP access network and the selected communication network.

9. The method of claim 8, wherein the selecting of a non-3GPP access network and a communication network is based on at least one of: service requirements determined at the UE or a configuration determined at the UE.

10. The method of claim 8, further comprising storing one or more of configuration or capability information.

11. The method of claim 8, wherein selection of the non-3GPP access network and the communication network is based at least in part on connectivity and functionality requirements determined at the UE.

12. A network node for wireless communication, comprising:
at least one memory; and
at least one processor coupled with the at least one memory and configured to cause network node to:
send information send to a wireless communications device, wherein the indicates:
a set of communication networks supported by a non-3GPP access network;
a connectivity to each communication network of the set of communication networks that is supported by the non-3GPP access network; and
at least one functionality provided by each communication network and that is supported by the non-3GPP access network; and
receive a registration request from the wireless communication device, the registration request initiating a registration with a selected non-3GPP access network and a selected communication network.

13. The network node of claim 12, wherein the information further comprises information about tracking area identities (TAIs) supported by the non-3GPP access network from which the information is received.

14. The network node of claim 12, wherein functionalities supported by each communication network comprise at least one of:
network access using credentials from a Credentials Holder;
a list of one or more Group IDs for Network Selection;
registration without explicit Standalone Non-Public Network (SNPN) selection configuration;
an onboarding service;
a list of services offered by a SNPN; or
identities or human readable names of functionalities or services.

15. The network node of claim 12, wherein the at least one processor is configured to cause the network node to receive an establishment cause, wherein the establishment cause comprises at least one of:
network access for device onboarding; or
network access for using a localized service.

16. The network node of claim 15, wherein the at least one processor is configured to cause the network node to send to the communication network the establishment cause.

17. (canceled)

18. A processor for wireless communication, comprising:
at least one controller coupled with at least one memory and configured to cause the processor to:
receive information from a non-3GPP access network, wherein the non-3GPP access network supports at least one functionality provided by a communication network, and wherein the information comprises:
a set of communication networks supported by the non-3GPP access network;
a connectivity to each communication network of the set of communication networks that is supported by the non-3GPP access network; and
at least one functionality provided by each communication network and that is supported by the non-3GPP access network;
select a non-3GPP access network and a communication network based at least in part on the received information; and
initiate a registration with the selected non-3GPP access network and the selected communication network.

19. The processor of claim 18, wherein the selection of a non-3GPP access network and a communication network is based on at least one of service requirements determined at a user equipment (UE) or a configuration determined at the UE.

20. The processor of claim 18, wherein functionalities supported by each communication network comprise at least one of:
network access using credentials from a Credentials Holder;
a list of one or more Group IDs for Network Selection;
registration without explicit Standalone Non-Public Network (SNPN) selection configuration;
a device onboarding service;
a list of services offered by a SNPN; or
identities or human readable names of functionalities or services.

21. The processor of claim 18, wherein the at least one controller is configured to cause the processor to transmit to the non-3GPP access network an establishment cause indicating at least one of:
a request for network access for device onboarding; or
network access for using a localized service.
